(19) United States
(12) Patent Application Publication
(10) Pub. No.: US 2026/0286888 A1
(43) Pub. Date: Sep. 24, 2026

(54) AIRCRAFT TURBINE ENGINE

(71) Applicant: SAFRAN AIRCRAFT ENGINES, Paris (FR)

(72) Inventors: Sebastien ORIOL, Moissy-Cramayel (FR); Didier Gabriel Bertrand DESOMBRE, Moissy-Cramayel (FR); Christophe Paul JACQUEMARD, Moissy-Cramayel (FR); Jonathan Jean-Pierre ROUFFET, Moissy-Cramayel (FR); Nicolas STOLIAROFF-PEPIN, Moissy-Cramayel (FR)

(21) Appl. No.: 18/998,020

(22) PCT Filed: Jul. 31, 2023
(86) PCT No.: PCT/FR2023/051219

§ 371 Date: Jan. 23, 2025

(30) Foreign Application Priority Data
Aug. 10, 2022 (FR) 2208224

(51) Int. Cl. F02C 7/06; F16N 7/02

(52) U.S. Cl. CPC F02C 7/06; F16N 7/02; F05D 2220/323; F05D 2260/98; F16N 2210/02; F16N 2210/08; F16N 2210/12

(57) ABSTRACT

A turbine engine for an aircraft, including an annular lubrication enclosure in which a speed reducer is arranged, a system for lubricating the speed reducer including a main lubrication circuit and an auxiliary lubrication circuit connected to the lubrication enclosure the auxiliary circuit being connected to an auxiliary reservoir an inner shroud extending around the lubrication enclosure and the auxiliary reservoir, being located outside the outer shroud one of the arms, referred to as the arm at 6 o'clock, being tubular and located at the 6 o'clock position, the lubrication enclosure including a deflector connected to the radially inner end of the arm at 6 o'clock and configured to deflect oil flowing by gravity from the lubrication enclosure towards the upstream compartment of the arm at 6 o'clock.

### TECHNICAL FIELD OF THE INVENTION

The invention relates to the aircraft turbine engine field. More specifically, the invention relates to the field of turbine engines comprising a system for lubricating a speed reduction gear, comprising main and auxiliary lubrication circuits.

### TECHNICAL BACKGROUND

An aircraft turbine engine typically comprises, from upstream to downstream in the direction of gas flow, a fan mobile in rotation around a longitudinal axis, a low-pressure compressor, a high-pressure compressor, a combustion chamber, a high-pressure turbine, a low-pressure turbine and a gas exhaust nozzle.

The fan allows the suction of an air stream divided into a primary stream and a secondary stream. The primary stream passes through a primary duct of the turbine engine while the secondary stream is directed towards a secondary duct surrounding the primary duct.

The turbine engine also comprises an inlet casing centered on the longitudinal axis and defining the inlet to the primary duct. The inlet casing comprises an annular internal shroud surrounded by an annular external shroud connected by radial arms.

The primary stream is compressed in the compressors. The compressed air is then mixed with a fuel and burned within the combustion chamber. The gases resulting from the combustion pass through the turbines then escape through the nozzle whose cross-section allows the acceleration of these gases to generate the propulsion.

The rotor of the low-pressure turbine is connected to the rotor of the low-pressure compressor by a low-pressure shaft and the rotor of the high-pressure turbine is connected to the rotor of the high-pressure compressor by a high-pressure shaft. In addition, the fan is driven in rotation by a fan shaft which is connected to the low-pressure shaft by a speed reduction gear, enabling the fan to be driven at a lower rotational speed than the rotational speed of the low-pressure shaft. The speed reduction gear is typically arranged in a lubrication enclosure for lubricating the speed reduction gear. The lubrication enclosure is typically located inside the internal shroud.

To ensure the lubrication of the reduction gear in the lubrication enclosure, the turbine engine also comprises a main lubrication circuit of the reduction gear connected to the lubrication enclosure. The main circuit comprises an oil supply pump of the reduction gear connected to a main oil reservoir. The oil supply pump is typically driven in rotation by the high-pressure shaft via an accessory gearbox.

During certain operating phases of the turbine engine, such as the free rotation phases of the fan (known as “windmilling”) during which the fan shaft is driven in rotation thus driving the low-pressure shaft, the rotational speed of the high-pressure shaft is insufficient to drive the supply pump at a speed sufficient to provide the flow rate required to lubricate the reduction gear. However, it is necessary to ensure lubrication of the speed reduction gear even during these operating phases of the turbine engine.

In this context, the turbine engine comprises an auxiliary lubrication circuit for the reduction gear. The auxiliary circuit typically comprises an auxiliary pump supplied with energy by an electric generator, for example, or driven by the low-pressure shaft, which enables the auxiliary pump to be primed even in the event of free rotation of the fan and low rotational speed of the high-pressure shaft.

In order to supply the auxiliary circuit with oil, the document FR-A1-3 075 875 proposes recovering the oil flowing by gravity into the bottom of the enclosure. To this end, one of the radial arms located at 6 o'clock has an internal cavity opening into the enclosure via an oil inlet. The arm also has a first oil outlet connected to the main circuit by a first pipe and a second oil outlet connected to the auxiliary circuit by a second pipe. The first pipe is connected to an oil recovery pump supplying the main reservoir and the second pipe is connected to an auxiliary pump in the auxiliary circuit.

In addition, according to this document, a radial bulkhead is arranged in the internal cavity and delimits an upstream compartment and a downstream compartment, the second pipe being connected to the upstream compartment and the first pipe being connected to the downstream compartment.

So, for example, during phases of free rotation of the fan when the supply pump is not primed, the auxiliary and recovery pumps draw the oil flowing by gravity into the arm located at 6 o'clock through each of the pipes. The auxiliary circuit can therefore be supplied with oil to lubricate the reduction gear during these phases.

Although this solution provides a volume of oil for auxiliary lubrication of the speed reduction gear in the event of free rotation of the fan, for example, the volume of oil available for these operating phases is not guaranteed and may prove insufficient. Indeed, this document teaches that to maximise oil recovery, the oil inlet has a maximum axial dimension extending over the entire axial width of the arm, defined between upstream and downstream axial walls of the arm. The combination of the configuration of the oil inlet and the presence of the radial wall prevents sufficient oil recovery in the first pipe. In fact, the oil flowing down the arm by gravity supplies both the upstream compartment and downstream compartment. The main circuit can therefore be supplied with oil even though the auxiliary circuit does not have sufficient volume during the operating phases of free rotation of the fan. During these phases, an insufficient lubrication of the reduction gear may occur, which could cause irreversible damage to the latter.

There is therefore a need to provide a turbine engine that ensures sufficient, effective and reliable lubrication of the speed reduction gear during all the operating phases of the turbine engine.

### SUMMARY OF THE INVENTION

To this end, the invention proposes a turbine engine for an aircraft, extending around a longitudinal axis and comprising:
a fan driven in rotation around the longitudinal axis by a fan shaft,
a low-pressure shaft connected to the fan shaft by a mechanical speed reduction gear,
an annular lubrication enclosure in which the speed reduction gear is arranged,
a system for lubricating the speed reduction gear comprising a main lubrication circuit and an auxiliary lubrication circuit connected to the lubrication enclosure, the auxiliary circuit being connected to an auxiliary reservoir,
an inlet casing comprising an internal shroud and an external shroud which are centered on the longitudinal axis and which are connected by arms, the internal shroud extending around said lubrication enclosure and the auxiliary reservoir being located outside the external shroud, one of the arms, called 6 o'clock arm, being tubular and located at 6 o'clock, this 6 o'clock arm comprising:
   a radially external end connected to the external shroud and an opposite radially internal end,
   an internal cavity opening into the lubrication enclosure via an oil inlet,
   a first oil outlet connected to the main circuit,
   a second oil outlet connected to the auxiliary reservoir, the first and second oil outlets being radially opposite the oil inlet, and
   a radial bulkhead arranged in the internal cavity and delimiting an upstream compartment and a downstream compartment, the second outlet being located in the upstream compartment and the first outlet being located in the downstream compartment.

The turbine engine according to the invention is remarkable in that the lubrication enclosure also comprises a deflector connected to the radially internal end of the 6 o'clock arm and configured to deflect the oil flowing by gravity from the lubrication enclosure towards the upstream compartment.

Thanks to the deflector of the arm, the oil flows in a privileged way into the upstream compartment connected to the auxiliary reservoir. When the volume of oil in the auxiliary reservoir exceeds the maximum volume of the auxiliary reservoir, this oil accumulates in the upstream compartment. When the volume of oil in the upstream compartment is at its maximum, the oil flowing by gravity overflows into the downstream compartment. This oil is then communicated to the main circuit. The auxiliary reservoir is therefore supplied with oil as a priority, which ensures lubrication of the speed reduction gear when the auxiliary circuit is active.

In addition, according to the invention, the auxiliary reservoir extends outside the external shroud. This configuration of the auxiliary reservoir allows a large-volume auxiliary reservoir without disturbing the flow of a primary stream in a primary duct delimited by the internal and external shrouds.

Thanks to the invention, a sufficient volume of oil can be stored in the auxiliary reservoir to supply the auxiliary circuit. The speed reduction gear can therefore be lubricated reliably and efficiently during all the operating phases of the turbine engine.

The invention may comprise one or more of the following characteristics, taken alone or in combination with each other:
the deflector comprises an axial wall connected to the 6 o'clock arm and to the internal shroud, the axial wall having a flow surface inclined towards the internal cavity in such a way that said axial wall moves continuously away from the longitudinal axis as it progresses upstream of the 6 o'clock arm,
the 6 o'clock arm comprises axially opposed upstream and downstream walls extending radially between the internal and external ends, the oil inlet being delimited axially by an edge of the deflector and the upstream wall of the 6 o'clock arm,
the deflector has a circumferential width equal to a circumferential width of the 6 o'clock arm,
the oil inlet has a passage cross-section equal to or greater than a passage cross-section of the first oil outlet,
the radially external end of the 6 o'clock arm has a bottom wall wherein the second oil outlet is formed, the bulkhead extending radially towards the inside of the 6 o'clock arm from the bottom wall,
a separation barrier is arranged in the internal cavity and extends radially from the deflector at least as far as the second oil outlet,
a vent is formed in the deflector and opens into the lubrication enclosure and the internal cavity on the side of the downstream compartment,
the auxiliary reservoir is connected directly to the second oil outlet,
the auxiliary reservoir is housed in an inter-vein compartment which separates an air stream produced by the fan into a primary stream and a secondary stream,
the main circuit comprises:
a recovery pump having a hydraulic inlet line and a hydraulic outlet line,
a hydraulic anti-cavitation line connected to the hydraulic output line of the recovery pump, and
a hydraulic auxiliary valve arranged between the recovery pump and the arm, the auxiliary valve comprising:
   a first inlet port connected to the first oil outlet,
   a second inlet port connected to the hydraulic anti-cavitation line,
   an outlet port connected to the hydraulic input line of the recovery pump, and, p2 a member movable between a first position in which the outlet port is in fluid communication with the first inlet port and a second position in which the outlet port is in fluid communication with the second inlet port.

### BRIEF DESCRIPTION OF THE FIGURES

Further characteristics and advantages will be apparent from the following description of non-limiting embodiments of the invention with reference to the accompanying drawings in which:

FIG. 1 is a schematic representation in longitudinal section of an aircraft turbine engine according to the invention,

FIG. 2 is a schematic representation in longitudinal cross-section of a speed reduction gear equipping the turbine engine of FIG. 1,

FIG. 3 is a schematic view of a system for lubricating the reduction gear in FIG. 2, according to one example of the invention,

FIG. 4 is a schematic view of a system for lubricating the reduction gear in FIG. 2, according to another embodiment of the invention,

FIG. 5a is a schematic view of the longitudinal section of the 6 o'clock arm according to a first embodiment of the invention,

FIG. 5b is a schematic view of the longitudinal section of the 6 o'clock arm according to a variant of the first embodiment of the invention,

FIG. 6a is a schematic view of the longitudinal section of the 6 o'clock arm according to the first embodiment, when the turbine engine is at a standstill and the main and auxiliary circuits are at a standstill,

FIG. 6b is a schematic view of the longitudinal section of the 6 o'clock arm according to the first embodiment, when the turbine engine is in a first nominal operating phase during which the volume of oil in the upstream compartment is less than the maximum volume of the upstream compartment, the main circuit being active and the auxiliary circuit at a standstill,

FIG. 6c is a schematic view of the longitudinal section of the 6 o'clock arm according to the first embodiment, when the turbine engine is in a second nominal operating phase during which the volume of oil in the upstream compartment is greater than the maximum volume of the upstream compartment, the main circuit being active and the auxiliary circuit at a standstill,

FIG. 6d is a schematic view of the longitudinal section of the 6 o'clock arm according to the first embodiment, when the turbine engine is in a third operating phase, for example free rotation of the fan, during which the auxiliary circuit is active.

FIG. 7 is a longitudinal sectional view of the 6 o'clock arm according to a second embodiment of the invention,

FIG. 8a is a schematic view of the longitudinal section of the 6 o'clock arm according to the second embodiment, when the turbine engine is at a standstill and the main and auxiliary circuits are at a standstill,

FIG. 8b is a schematic view of the longitudinal section of the 6 o'clock arm according to the second embodiment, when the turbine engine is in a first nominal operating phase during which the volume of oil in the upstream compartment is less than the maximum volume of the upstream compartment, the main circuit being active and the auxiliary circuit at a standstill,

FIG. 8c is a schematic view of the longitudinal section of the 6 o'clock arm according to the second embodiment, when the turbine engine is in a second nominal operating phase during which the volume of oil in the upstream compartment is greater than the maximum volume of the upstream compartment, the main circuit being active and the auxiliary circuit at a standstill,

FIG. 8d is a schematic view of the longitudinal section of the 6 o'clock arm according to the second embodiment, when the turbine engine is in a third operating phase, for example free rotation of the fan, during which the auxiliary circuit is active.

### DETAILED DESCRIPTION OF THE INVENTION

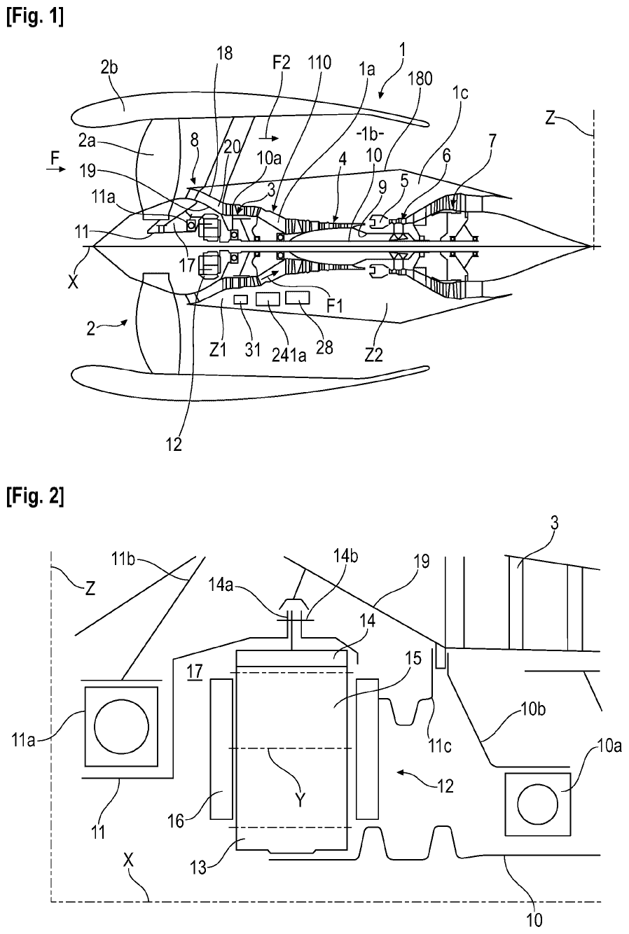

An example of an aircraft turbine engine 1 according to the invention is shown in FIG. 1. The turbine engine 1 extends around and along a longitudinal axis X.

In this application, the terms “axial”, “axially”, “radial” and “radially” are defined in relation to the longitudinal axis X.

The terms “upstream” and “downstream” are defined in relation to the direction of gas flow in the turbine engine 1 along the longitudinal axis X.

The terms “internal”, “inner”, “external”, “outer” and “externally” are defined in relation to the distance from the longitudinal axis X along a radial axis Z perpendicular to the longitudinal axis X.

The terms “horizontal” and “vertical” are defined in relation to the direction of gravity, which defines the vertical. The horizontal is perpendicular to the direction of gravity and the vertical is parallel to the direction of gravity.

The turbine engine 1 comprises, from upstream to downstream, a fan 2, at least one compressor such as a low-pressure compressor 3 and a high-pressure compressor 4, a combustion chamber 5, at least one turbine such as a high-pressure turbine 6 and a low-pressure turbine 7, and a nozzle for exhausting the gases.

The fan 2 draws in an air stream F divided into a primary stream F1 and a secondary stream F2. The primary stream F1 passes through a primary duct 1a of the turbine engine 1, while the secondary stream F2 is directed towards a secondary duct 1b surrounding the primary duct 1a.

The primary stream F1 is compressed in the low-pressure compressor 3 and then in the high-pressure compressor 4. The compressed air is then mixed with a fuel and burned in the combustion chamber 5. The gases formed by the combustion pass through the high-pressure 6 and the low-pressure 7 turbines. The gases escape finally through the nozzle whose cross-section allows the acceleration of these gases to generate the propulsion.

The fan 2 is mobile in rotation around the longitudinal axis X. The fan 2 comprises vanes 2a evenly distributed around a disk centered on the longitudinal axis X.

The fan 2 is for example ducted. The turbine engine 1 then comprises an annular nacelle 2b centered on the longitudinal axis X surrounding the fan 2. The nacelle 2b, for example, is supported by a fan casing (not shown).

The turbine engine 1 also comprises an inlet casing 8. The inlet casing 8 is located inside the nacelle 2b, for example. The inlet casing 8, for example, is arranged axially between the fan 2 and the low-pressure compressor 3. The inlet casing 8 forms an inlet spout for the primary duct 1a. In particular, the inlet casing 8 comprises an external shroud 18 and an internal shroud 19 arranged in the external shroud 18. The external and internal shrouds 18, 19 are centered on the longitudinal axis X and connected by radial arms.

The primary duct 1a is delimited downstream of the inlet spout by internal casings 110 arranged downstream of the external shroud 18 and the internal shroud 19.

The secondary duct 1b is also radially delimited by the nacelle 2b and an inter-vein casing 180 arranged radially between the nacelle 2b and the inlet casing 8.

In addition, an inter-vein compartment 1c is arranged radially between the secondary duct 1b and the primary duct 1a. The inter-vein compartment 1c has a first area Z1 delimited on the inside by the external shroud 18 and on the outside by the inter-vein casing 180. The inter-vein compartment 1c comprises a second area Z2 downstream of the first area Z1.

In the particular example shown in FIG. 1, the rotor of the low-pressure turbine 7 is connected to the rotor of the low-pressure compressor 3 by a low-pressure shaft 10. The rotor of the high-pressure turbine 6 is connected to the rotor of the high-pressure compressor 4 by a high-pressure shaft 9. The low-pressure shaft 10 is arranged inside the high-pressure shaft 9 in a coaxial manner and extends along the longitudinal axis X.

The low-pressure shaft 10 is guided in rotation by bearings. An intermediate bearing 10a, for example, is arranged radially between the low-pressure shaft 10 and a first bearing support 10b connected, for example, to the internal shroud 19. The intermediate bearing 10a is a ball bearing, for example.

The fan 2 is driven in rotation by a fan shaft 11. The fan shaft 11 is connected to the disc for its rotational drive. The fan shaft 11 is supported by a downstream bearing 11a arranged radially between the fan shaft 11 and a second bearing support 11b connected to the internal shroud 19. The downstream bearing 11a is for example a ball bearing. It is located upstream of the intermediate bearing 10a. The downstream bearing 11a is arranged on a downstream end of the fan shaft 11.

The fan shaft 11 is also connected to the low-pressure shaft 10 by means of a speed reduction gear 12. The speed reduction gear 12 is of mechanical type.

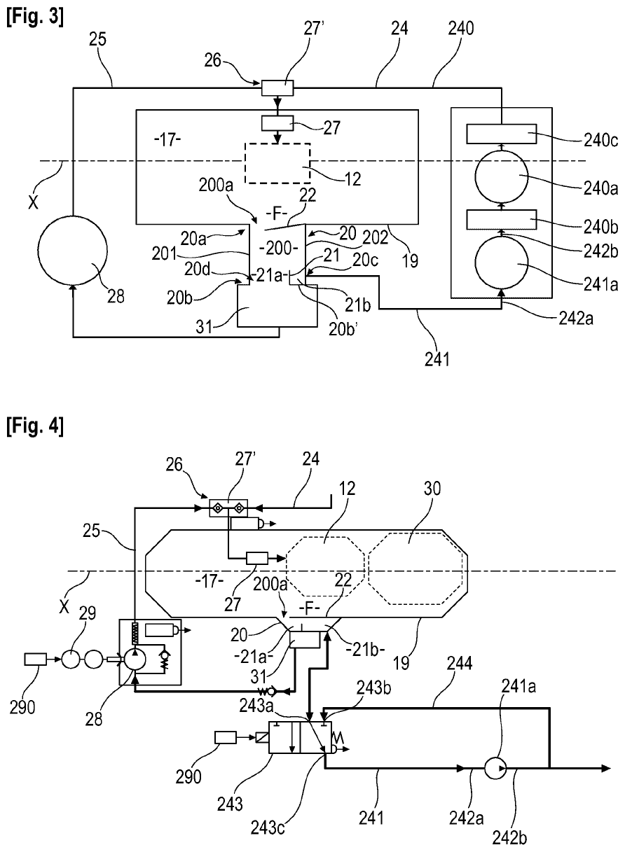

As best seen in FIG. 2, the speed reduction gear 12 comprises a sun gear 13, a ring gear 14, at least one planet gear 15 that meshes with the ring gear 14 and the sun gear 13, and a planet carrier 16.

The sun gear 13 is coupled in rotation with the low-pressure shaft 10. It forms the inlet of the reduction gear 12.

The speed reduction gear 12 comprises a plurality of planet gears 15. Each planet gear 15 has a central axis Y parallel to the longitudinal axis X. The ring gear 14 is annular and is arranged around the longitudinal axis X. According to the example in FIG. 1, the ring gear 14 is coupled in rotation with the fan shaft 11. The ring gear 14 comprises for example an attachment flange 14a connected to the fan shaft 11 for example by means of attachment rods 14b such as screws. The ring gear 14 forms the outlet of the reduction gear 12.

The planet carrier 16 is stationary in rotation around the longitudinal axis X. The planet carrier 16 is connected to a stationary structure of the turbine engine 1. As shown in FIG. 2, the planet carrier 16 is connected to the internal shroud 19, for example via a flexible support 11c.

The speed reduction gear 12 is made up of gears and rolling bearing that require lubrication. To this end, the lubricating oil is sprayed onto the speed reduction gear 12. In order to protect the other members of the turbine engine 1 from this oil, the speed reduction gear 12 is arranged in an annular lubrication enclosure 17. The lubrication enclosure 17 is, for example, an upstream enclosure. The lubrication enclosure 17 is located inside the internal shroud 19. It may comprise the upstream bearing 11a and the intermediate bearing 10a.

The lubrication enclosure 17 has a enclosure bottom F. The enclosure bottom F is located at the lowest point of the lubrication enclosure 17, i.e. the internal shroud 19. The lubricating oil flows by gravity into the enclosure bottom F.

Among the radial arms extending radially between the external shroud 18 and the internal shroud 19, a tubular arm 20 is located at 6 o'clock (six o'clock) by analogy with the corresponding position on the dial of a clock. For simplicity, this 6 o'clock arm will be referred to as the “arm” in the remainder of the description.

The arm 20 comprises a radially internal end 20a for example connected to the lubrication enclosure 17, in particular to the enclosure bottom F. The radially internal end 20a is for example open. The arm 20 also comprises a radially external end 20b connected to the external shroud 18 and opposite the radially internal end 20a. The radially external end 20b has an axial bottom wall 20b′ preferably formed by the external shroud 18.

The arm 20 also has a first face and a second face opposite each other and extending radially between the radially external end 20b and the radially internal end 20a. The first and second faces meet at an upstream edge 201 and a downstream edge 202. The upstream and downstream edges 201, 202 are connected axially to each other at their upper end by the bottom wall 20b′.

The arm 20 also comprises an internal cavity 200 which opens into the lubrication enclosure 17, and in particular into the enclosure bottom F, via an oil inlet 200a. The lubricating oil can therefore flow by gravity out of the lubrication enclosure 17 into the arm 20. The oil inlet 200a is formed, for example, in the internal shroud 19 and opens into the internal cavity 200.

The arm 20 also comprises a first oil outlet 20c and a second oil outlet 20d radially opposite the oil inlet 200a. For example, they are formed in the bottom wall 20b′ and/or the downstream wall 202. The first outlet 20c is for example formed in the downstream wall 202 and the second outlet 20d is for example formed in the bottom wall 20b′. The oil inlet 200a has a first passage cross-section S1 and the first oil outlet 20c has a second passage cross-section S2. Preferably, the first passage cross-section S1 is greater than or equal to the second passage cross-section S2.

The arm 20 also comprises a radial bulkhead 21 arranged in the internal cavity 200. The radial bulkhead 21 is arranged axially between the first and second outlets 20c, 20d. The radial bulkhead 21 is located downstream of the oil inlet 200a. The radial bulkhead 21 delimits an upstream compartment 21a and a downstream compartment 21b in the arm 20. The upstream and downstream compartments 21a, 21b each have a predetermined volume. The first outlet 20c is located in the downstream compartment 21b and the second outlet 20d is located in the upstream compartment 21a.

The radial bulkhead 21 extends radially towards the inside from the bottom wall 20b′. The radial bulkhead 21 has a radially internal free end 210, opposite the bottom wall 20b′.

Preferably, the radial bulkhead 21 has a maximum height H configured so that the volume of the upstream compartment 21a is sufficient to prevent oil from overflowing into the lubrication enclosure 17 when the turbine engine 1 tilts upstream at the maximum permitted angle, typically during a nose-down manoeuvre of the aircraft.

The free end 210 is located outside a first straight line D1 passing through the internal end of the upstream wall 201 and parallel to a horizontal plane when the turbine engine 1 is inclined upstream at a maximum permitted angle of inclination. This prevents oil from overflowing into the lubrication enclosure 17 when the turbine engine 1 is tilted upstream to the maximum permitted angle, typically during a nose-down manoeuvre of the aircraft. For example, the ratio between the maximum height H of the radial bulkhead 21 and the height H′ of the upstream wall 201 is between 40% and 90%.

According to the invention, the lubrication enclosure 17 also comprises a deflector 22 connected to the radially internal end 20a of the arm 20. The deflector 22 is configured to deflect the oil flowing by gravity from the lubrication enclosure 17 towards the upstream compartment 21a. The deflector 22 is connected to the internal shroud 19. It preferably forms a single piece with the internal shroud 19. In another example, the deflector 22 and the internal shroud 19 may be two separate parts connected to each other.

The deflector 22 comprises an axial wall 22a connected to the internal shroud 19 and to the arm 20, in particular to the lower end of the downstream wall 202 of the arm 20. The axial wall 22a has a flow surface inclined towards the internal cavity 200 of the arm 20. In this way, the axial wall 22a moves continuously away from the longitudinal axis X as it moves upstream of the arm 20. Preferably, the axial wall 22a is inclined at an angle of inclination or slope a of between 5° and 45° relative to the longitudinal axis X. Such a slope a ensures that the oil flows by gravity into the upstream compartment 21a despite a downstream inclination of the turbine engine 1, typically during a nose-up manoeuvre of the aircraft, during the take-off phases of the aircraft for example.

Advantageously, the deflector 22 has a circumferential width equal to a circumferential width of the arm 20. The deflector 22 extends circumferentially between the first and second faces of the arm 22. This prevents oil from flowing by gravity into the downstream compartment 21b. The deflector 22 partially covers the radially internal end 20a of the arm 20. The deflector 22 has an edge 22b axially opposite the downstream wall 202 of the arm 20. This edge 22b delimits the oil inlet 200a axially with the upstream wall 201 of the arm 20.

Preferably, the radial bulkhead 21 is positioned in the internal cavity 200 of the arm 20 so that the oil flows from the bottom of the enclosure F into the upstream compartment 21a when the turbine engine 1 is tilted downstream at the maximum permitted angle, typically during a nose-up manoeuvre of the aircraft, during the take-off phases of the aircraft for example.

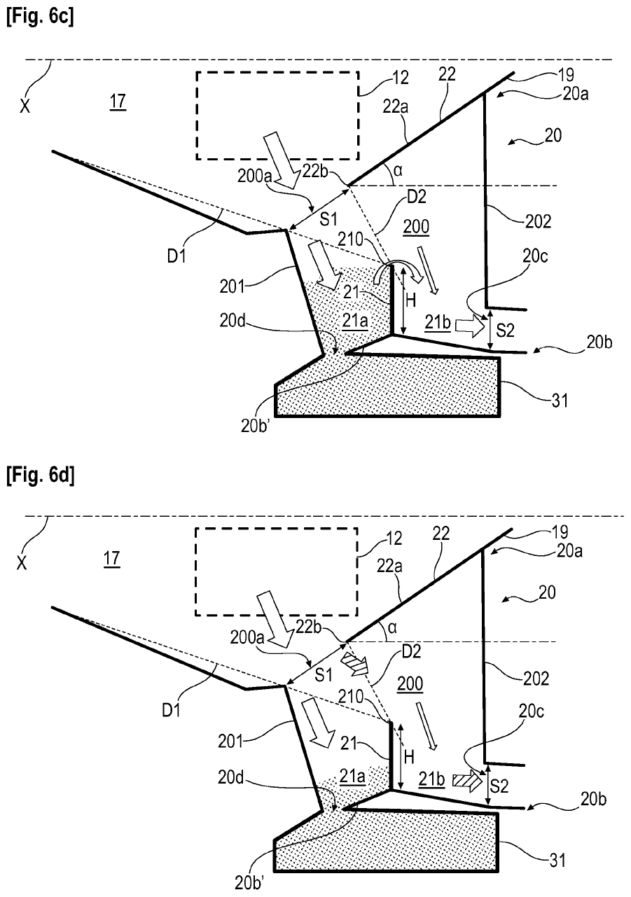

According to a first embodiment shown in FIGS. 5a and 5b, the free end 210 of the bulkhead 21 is located on or downstream of a second straight line D2 passing through the free edge 22b of the deflector 22 and parallel to a vertical plane when the turbine engine 1 is tilted downstream at a maximum authorised angle of inclination. This ensures that oil flows into the upstream compartment 21a rather than the downstream compartment 21b during a nose-up manoeuvre of the aircraft.

According to a variant of the first embodiment shown in FIG. 5b, the bulkhead 21 has a curved section 211 connected to the bottom wall 20b′. This increases the volume of the upstream compartment 20a. According to this variant, in order to minimise pressure losses, the second cross-section S2 is smaller than an intermediate oil passage cross-section S3 of the downstream compartment 21b.

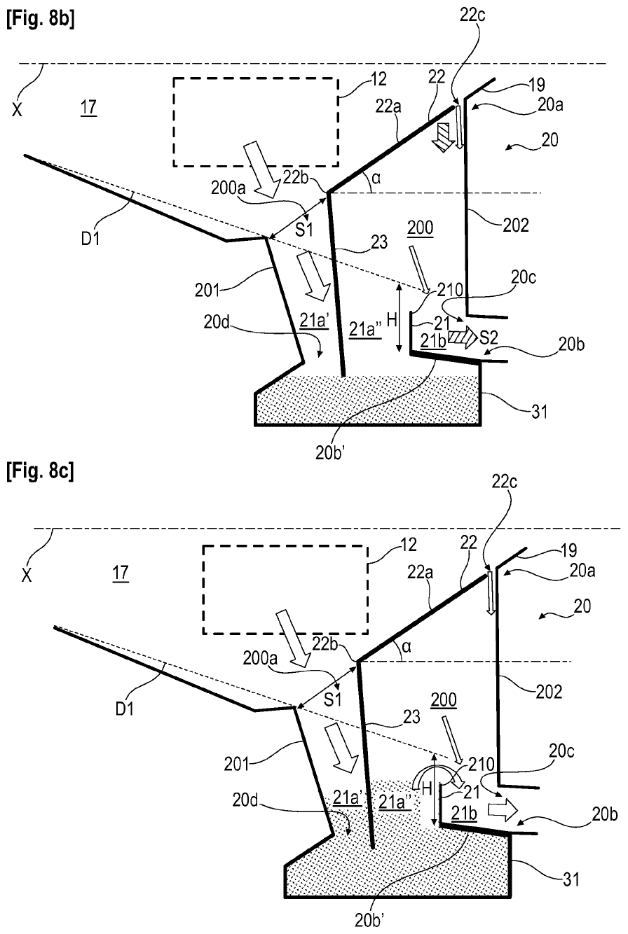

In a second embodiment shown in FIG. 7, a separation barrier 23 is arranged in the upstream compartment 21a. The separation barrier 23 separates the upstream compartment 21a into a first sub-compartment 21a′ and a second sub-compartment 21a″. The second sub-compartment 21a″ is located between the downstream compartment 21b and the first sub-compartment 21a′. The first and second sub-compartments 21a′, 21a″ are separated by the separation barrier 23.

Preferably, the separation barrier 23 extends radially towards the outside from the deflector 22 and extends at least as far as the second outlet 20d. In the example shown in FIG. 7, the separation barrier 23 extends into the second outlet 20d. Even more preferably, the separation barrier 23 is connected to the edge 22b of the deflector 22. The separation barrier 23 and the deflector 22 may form a single part or two separate parts joined together by gluing, for example.

Preferably, a vent 22c is formed in the axial wall 22a of the deflector 22. The vent 22c is continuous and opens into the lubrication enclosure 17 and into a part of the internal cavity 200 located on the side of the downstream compartment 21b.

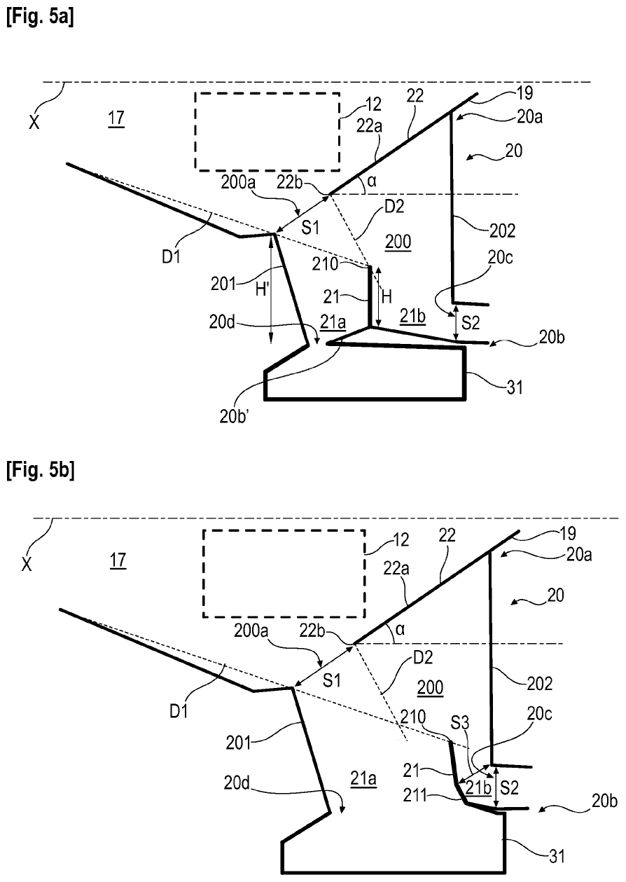

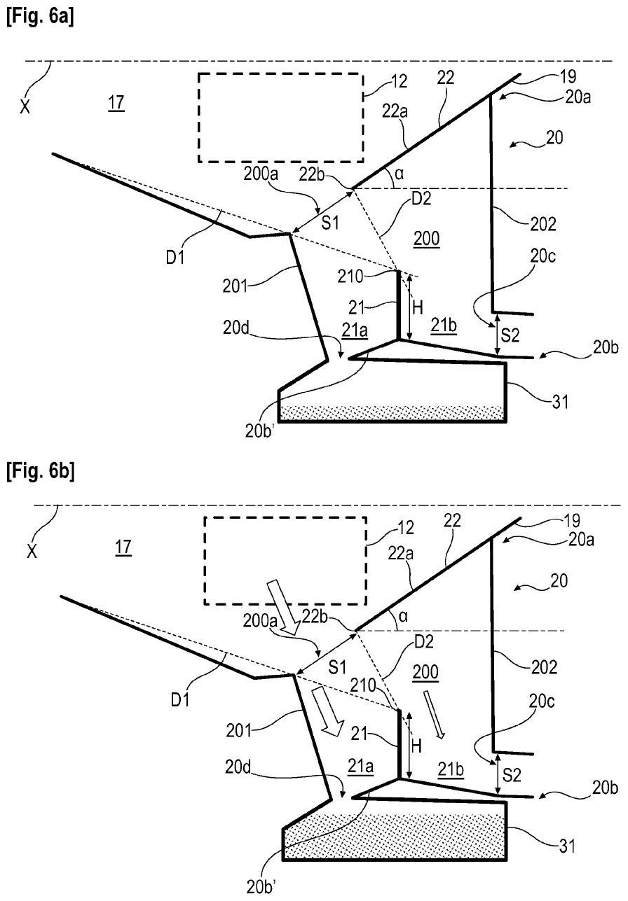

In order to ensure lubrication of the speed reduction gear 12 in the lubrication enclosure 17, the turbine engine 1 comprises a system for lubricating the speed reduction gear 12 shown, for example, in FIGS. 3 and 4.

The lubrication system comprises a main lubrication circuit 24 and an auxiliary lubrication circuit 25, the main and auxiliary circuits 24, 25 being connected to the lubrication enclosure 17. The lubrication system 23 may also comprise a selective spraying device 26 for spraying lubricating oil into the lubrication enclosure 17, this selective spraying device 26 being connected to the main circuit 24 and to the auxiliary circuit 25.

The main circuit 24 typically comprises a supply circuit 240 connecting a main reservoir 240b to the lubrication enclosure 17. The supply circuit 240 comprises a supply pump 240a mounted between the main reservoir 240b and the lubrication enclosure 17, in particular between the main reservoir 240b and the selective spraying device 26. The supply pump 240a, for example, is mechanically driven by the high-pressure shaft 9. Advantageously, the supply pump 240a is connected to the high-pressure shaft 9 via an accessory gearbox (AGB). The accessory box is housed in the inter-vein compartment 1c, for example. Thus, when the high-pressure shaft 9 is driven rotation, it initiates the supply pump 240a which draws oil from the main reservoir 240b and supplies oil to the selective spray device 26. The feed circuit 240 may also comprise at least one air/oil exchanger 240c arranged, for example, between the selective spraying device 26 and the supply pump 240a.

The main circuit 24 also comprises a return circuit 241 connecting the main reservoir 240b to the downstream compartment 21b of the arm 20. The return circuit 241 comprises a recovery pump 241a which is advantageously located in the inter-vein compartment 1c. The recovery pump 241a is connected to the main reservoir 240b and to the first outlet 20c of the arm 20. In particular, the recovery pump 241a has an inlet hydraulic line 242a connected to the first outlet 20c and an outlet hydraulic line 242b which is connected to the main reservoir 240b.

In some cases, the high-pressure shaft 9 is not driven in rotation or is driven at a speed that is insufficient to drive the supply pump 240a in rotation. For example, when the fan 2 is in free rotation (or auto-rotation, also known as “windmilling”), or during the start-up or shutdown phases of the turbine engine 1, the supply pump 240a is not primed and is no longer able to supply oil to the selective spraying device 26. The speed reduction gear 12 is then no longer lubricated by the main circuit 24. In this case, lubrication of the speed reduction gear 12 is provided by the auxiliary circuit 25.

The auxiliary circuit 25 is a closed lubrication circuit for lubrication enclosure 17. It comprises an auxiliary pump 28 connected to an auxiliary reservoir 31 and to the lubrication enclosure 17, in particular to the selective spraying device 26.

The auxiliary reservoir 31 is located outside the external shroud 18. Preferably, the auxiliary reservoir 31 is located in the inter-vein compartment 1c, for example in the first area Z1. As the auxiliary reservoir 31 is located outside the primary duct 1a, the auxiliary reservoir 31 can have a large internal volume without affecting the aerodynamic performance of the turbine engine 1. This means a large volume of oil can be stored.

The auxiliary reservoir 31 is connected to the second oil outlet 20d of the arm 20. In this way, the auxiliary reservoir 31 and the upstream compartment 21a are connected. The oil flowing by gravity into the upstream compartment 21a is stored in the auxiliary reservoir 31. Thanks to the invention's deflector 22, the auxiliary reservoir 31 is filled as a priority. The risk of under-supplying the auxiliary reservoir 31 with oil is limited. This ensures reliable lubrication of the speed reduction gear 12 whatever the operating phases of the turbine engine 1.

Preferably, the auxiliary reservoir 31 is directly connected to the second oil outlet 20d of the arm 20.

The auxiliary pump 28 is driven, for example, by an electric engine 29. The auxiliary pump 28 and electric engine 29, for example, are located in the inter-vein compartment 1c. The electric engine 29 is supplied with electrical energy by an electrical generator (not shown) located, for example, in the lubrication enclosure 17. The electrical generator supplies electrical energy to the electric engine 29 from mechanical energy. For example, the electrical generator draws mechanical energy from the fan shaft 11. For example, the electric generator is connected to the fan shaft 11 via gears 30.

The electric engine is controlled by a control unit 290, for example. The control unit 290 modulates the speed of the auxiliary pump 28 via the electric engine. The control unit is a Full Automatic Digital Engine Control (FADEC), for example.

In another example, the auxiliary pump 28 is driven by the low-pressure shaft 10.

The selective spraying device 26 comprises, for example, a selection member 27′ and at least one sprinkler 27 which is arranged in the lubrication enclosure 17. The selection member 27′ is, for example, a selection valve connected to the main and auxiliary circuits 24, 25.

The sprinkler 27 allows to project lubricating oil into the lubrication enclosure 17. The selective spray device 26 advantageously comprises two sprinklers 27, a first sprinkler spraying lubricating oil onto the speed reduction gear 12 and a second sprinkler spraying oil onto the gears 30. The sprinklers are connected to the selection member 27′ and are supplied with lubricating oil by one of the circuits 24, 25 depending on the position of the selection valve.

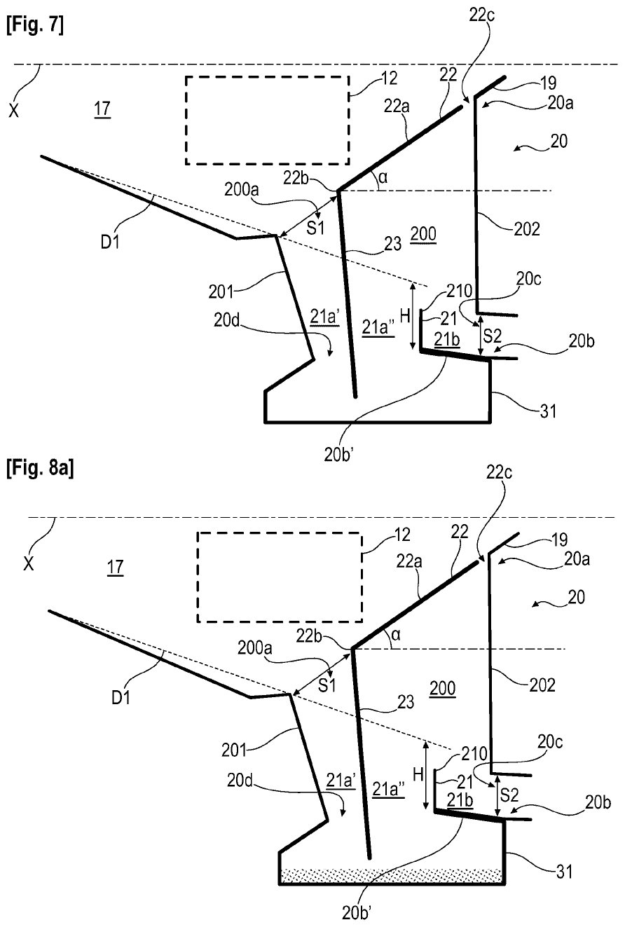

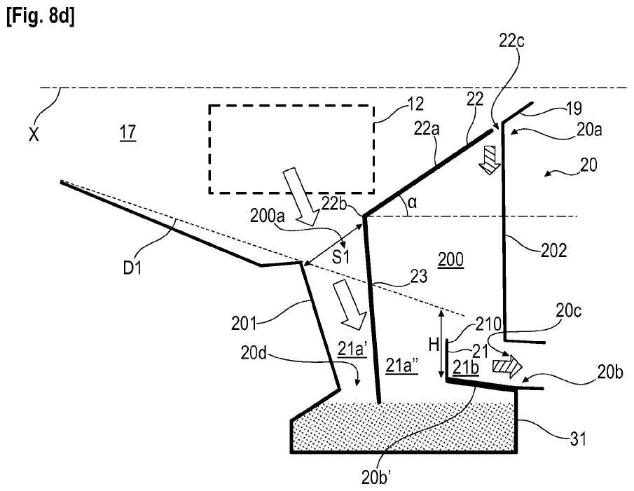

The operation of the main and auxiliary circuits 24, 25 will now be described with reference to FIGS. 6a to 6d and 8a to 8d.

In FIGS. 6a and 8a, the turbine engine 1 is at a standstill. The main and auxiliary circuits 24, 25 are therefore stopped. In this first phase, the auxiliary reservoir 31 comprises oil remaining from a previous flight.

In a first nominal operating phase of the turbine engine 1 illustrated in FIGS. 6b and 8b, the auxiliary circuit 25 is inactive, i.e. the auxiliary pump 28 is inactive. The main circuit 24 is active, i.e. the supply pump 240a is active and draws oil from the main reservoir 240b. The oil is conveyed to the lubrication enclosure 17 via the main circuit 24. In this first phase, the lubricating oil flows by gravity into the enclosure bottom F and flows into the arm 20. Thanks to the deflector 22, the oil flows preferentially into the upstream compartment 21a as indicated by the non-hatched arrows. This oil is stored in the auxiliary reservoir 31. During this phase, the volume of oil in the upstream compartment 21a is less than the maximum volume of the upstream compartment 21a. The recovery pump 241a is also active, for example. A small quantity of oil flowing by gravity into the internal cavity 200 of the arm 20 can be drawn off by the recovery pump 241a.

During this phase, depending on the sizing of the recovery pump 241a, there is a risk that it will draw a large volume of oil from the upstream compartment 21a. In order not to drain the oil from the upstream compartment 21a, in the second embodiment shown in FIG. 8b, the vent 22c allows air to be drawn from the lubrication enclosure 17 by the recovery pump 241a as shown by the hatched arrows.

In a second nominal operating phase of the turbine engine 1 illustrated in FIGS. 6c and 8c, the main circuit 24 is still active but the volume of oil in the auxiliary reservoir 31 is greater than the maximum volume of the auxiliary reservoir 31 and the maximum volume of the upstream compartment 21a. The oil overflows into the downstream compartment 21b. In this second phase, the recovery pump 241a draws oil from the downstream compartment 21b, allowing it to circulate in the return circuit 241 of the main circuit 24 to supply oil to the main reservoir 240b.

In a third operating phase of the turbine engine 1 illustrated in FIGS. 6d and 8d, for example in the event of free rotation of the fan 2 and stoppage or insufficient speed of rotation of the high-pressure shaft 10, the pressure in the main circuit 24 decreases so that the selection member 27′ becomes supplied by the auxiliary circuit 25 in which the oil pressure is higher. The supply pump 240a is then de-primed or supplies an insufficient flow, while the auxiliary circuit 25 is active. The auxiliary pump 28 draws the oil from the auxiliary reservoir 31 and allows it to circulate in the auxiliary circuit 25 to lubricate the reduction gear 12 in the lubrication enclosure 17. The recovery pump 241a can still rotate at a sufficient speed to cause the pump to draw in a significant amount of air from the upstream compartment 21a, as shown by the hatched arrows.

Such air suction can cause cavitation damage to the recovery pump 241a.

To limit this risk of cavitation, according to a particularly advantageous embodiment illustrated in FIG. 4, the return circuit 241 comprises a hydraulic auxiliary valve 243 arranged between the arm 20 and the recovery pump 241a and a hydraulic anti-cavitation line 244 connected to the hydraulic output line 242b of the recovery pump 241a.

The auxiliary valve 243 comprises a first inlet port 243a connected to the first oil outlet 20c of the arm 20, a second inlet port 243b connected to the anti-cavitation hydraulic line 244 and an outlet port 243c connected to the hydraulic inlet line 242a of the recovery pump 241a.

The auxiliary valve 243 further comprises a member movable between a first position in which the outlet port 243c is in fluid communication with the first inlet port 243a and a second position in which the outlet port 243c is in fluid communication with the second inlet port 243b. In the first position, the recovery pump 241a draws oil from the downstream compartment 21b, while in the second position, the recovery pump 241a draws oil from the main reservoir 240b.

The auxiliary valve 243 is, for example, a spring-loaded valve.

Preferably, the auxiliary valve 243 has an electrical control system. For example, it is controlled by the control unit 290.

Thus, when the turbine engine 1 is in the third operating phase, for example with the fan 2 rotating freely, the control unit 290 controls the auxiliary valve 243 in the second position. The recovery pump 241a can therefore draw oil from the main reservoir 240b and not air from the downstream compartment 21b. This type of embodiment therefore limits the risk of damage to the recovery pump 241a by cavitation.

Thanks to the invention, it is possible to increase the volume of the auxiliary reservoir 31 without impacting the aerodynamic performance and overall dimensions of the turbine engine 1.

Thanks to the invention, it is possible to guarantee a sufficient volume of oil in the auxiliary reservoir 31 for lubrication of the speed reduction gear 12 in the lubrication enclosure 17 in the event of stoppage of the supply pump 240a of the main circuit 24, for example in the event of free rotation of the fan 2.

Thanks to the advantageous embodiment of the invention, it is possible to supply the upstream compartment 21a despite a nose-up manoeuvre of the aircraft.

Thanks to the advantageous embodiment of the invention, the risks of oil overflowing from the upstream compartment 21a into the lubrication enclosure 17 in the event of nose-down manoeuvring of the aircraft are reduced.

1. A turbine engine for an aircraft, extending around a longitudinal axis and comprising:
a fan driven in rotation around the longitudinal axis by a fan shaft,
a low-pressure shaft connected to the fan shaft by a mechanical speed reduction gear,
an annular lubrication enclosure in which the speed reduction gear is arranged,
a system for lubricating the speed reduction gear comprising a main lubrication circuit and an auxiliary lubrication circuit connected to the lubrication enclosure the auxiliary circuit being connected to an auxiliary reservoir,
an inlet casing comprising an internal shroud and an external shroud which are centered on the longitudinal axis and which are connected by arms, the internal shroud extending around said lubrication enclosure and the auxiliary reservoir being located outside the external shroud, one of the arms, called the 6 o'clock arm, being tubular and located at 6 o'clock, this 6 o'clock arm comprising:
a radially external end connected to the external shroud and an opposite radially internal end,
an internal cavity opening into the lubrication enclosure via an oil inlet,
a first oil outlet connected to the main circuit,
a second oil outlet connected to the auxiliary reservoir, the first and second oil outlets, being radially opposite the oil inlet, and
a radial bulkhead arranged in the internal cavity and delimiting an upstream compartment and a downstream compartment the second outlet being located in the upstream compartment and the first outlet being located in the downstream compartment,
wherein the lubrication enclosure further comprises a deflector connected to the radially internal end of the 6 o'clock arm and configured to deflect oil flowing by gravity from the lubrication enclosure towards the upstream compartment.

2. The turbine engine according to claim 1, wherein the deflector comprises an axial wall connected to the 6 o'clock arm and to the internal shroud the axial wall having a flow surface inclined towards the internal cavity in such a way that said axial wall moves continuously away from the longitudinal axis as it progresses upstream of the 6 o'clock arm.

3. The turbine engine according to claim 1, wherein the 6 o'clock arm comprises axially opposed upstream and downstream walls extending radially between the internal and external ends the oil inlet being delimited axially by an edge of the deflector and the upstream wall of the 6 o'clock arm.

4. The turbine engine according to claim 1, wherein the deflector has a circumferential width equal to a circumferential width of the 6 o'clock arm.

5. The turbine engine according to claim 1, wherein the oil inlet has a passage cross-section equal to or greater than a passage cross-section of the first oil outlet.

6. The turbine engine according to claim 1, wherein the radially external end of the 6 o'clock arm has a bottom wall wherein the second oil outlet is formed, the bulkhead extending radially towards the inside of the 6 o'clock arm from the bottom wall.

7. The turbine engine according to claim 1, wherein a separation barrier is arranged in the internal cavity and extends radially from the deflector at least as far as the second oil outlet.

8. The turbine engine according to claim 7, wherein a vent is formed in the deflector and opens into the lubrication enclosure and into the internal cavity on the side of the downstream compartment.

9. The turbine engine according to claim 1, wherein the auxiliary reservoir is directly connected to the second oil outlet.

10. The turbine engine according to claim 1, wherein the auxiliary reservoir is housed in an inter-vein compartment which separates an air stream produced by the fan into a primary stream and a secondary stream.

11. The turbine engine according to claim 1, wherein the main circuit comprises:
a recovery pump having a hydraulic inlet line and a hydraulic outlet line,
a hydraulic anti-cavitation line connected to the hydraulic output line of the recovery pump, and
a hydraulic auxiliary valve arranged between the recovery pump and the arm the auxiliary valve comprising:
a first inlet port connected to the first oil outlet,
a second inlet port connected to the hydraulic anti-cavitation line
an outlet port connected to the hydraulic input line of the recovery pump, and,
a member movable between a first position in which the outlet port is in fluid communication with the first inlet port and a second position in which the outlet port is in fluid communication with the second inlet port.
